(19) United States
(12) Patent Application Publication
(10) Pub. No.: US 2009/0060055 A1
(43) Pub. Date: Mar. 5, 2009

(54) METHOD AND APPARATUS FOR ENCODING METADATA INTO A DIGITAL PROGRAM STREAM

(75) Inventors: Robert Blanchard, Escondido, CA (US); Mark Eyer, Woodinville, WA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 11/847,232

(22) Filed: Aug. 29, 2007

(51) Int. Cl. H04N 7/12

(52) U.S. Cl. 375/240.26; 375/E07.02

(57) ABSTRACT

A method and apparatus for encoding data into a digital program stream includes receiving a digital program stream having a pre-allocated data channel, where the pre-allocated data channel has a pre-defined bandwidth. In one embodiment, metadata may be received and an unused portion of the pre-defined bandwidth of the pre-allocated channel may be determined. In another embodiment, metadata may be encoded into the unused portion of the pre-defined bandwidth.

### FIELD OF THE INVENTION

The present invention relates in general to a method and apparatus for encoding metadata into a digital program stream.

### BACKGROUND

Traditional television broadcasting devices have enabled additional broadcast-related information to be transmitted along with broadcast programs, (e.g., closed captioning). In analog television formats, such as NTSC, additional information may be encoded in the vertical blanking interval (VBI). As television formats progress to all digital systems, the VBI is no longer utilized for carrying information. Further, digital program streams do not include a VBI. With the expansion of high bandwidth networks providing an increasing volume of information and the adoption of digital transmission networks, there exists a need for providing additional information along with broadcasted audio and video content. One way existing broadcast systems have supplied additional information with broadcast media is to rely on separate transmission paths such as phone lines or the internet. However, as additional broadcast-related data is passed using conventional methods through networks, cable and satellite systems, or broadcast plants, the additional broadcast data is susceptible to corruption or loss. As such, a reliable path is needed to provide data such as program guide information to end user devices (e.g., digital televisions, set top boxes, etc.). Additionally, a universal method is needed for properly handling data from broadcast sources such that end user devices may properly utilize such information.

### BRIEF SUMMARY OF THE INVENTION

Disclosed and claimed herein are methods and apparatus for encoding data into a digital program stream. In one embodiment, a digital program stream having a pre-allocated data channel is received from a broadcast source, wherein the pre-allocated data channel has a pre-defined bandwidth. According to another embodiment, the method includes receiving metadata. The method further includes determining an unused portion of the pre-defined bandwidth of the pre-allocated channel and encoding the metadata into the unused portion of the pre-defined bandwidth.

Other aspects, features, and techniques of the invention will be apparent to one skilled in the relevant art in view of the following detailed description of the invention.

### BRIEF DESCRIPTION OF THE DRAWINGS

FIG. 1 depicts an apparatus for encoding a digital program stream according to one or more embodiments of the invention;

FIG. 2 depicts an exemplary representation of a digital program stream according to one embodiment of the invention;

FIG. 3 depicts a simplified system diagram according to one or more aspects of the invention; and

FIG. 4 depicts a method of encoding data according to one embodiment of the invention.

### DETAILED DESCRIPTION OF EXEMPLARY EMBODIMENTS

One aspect of the present invention is directed to encoding data within a digital program stream. In one embodiment, an encoding process is provided such that data may be encoded into a pre-allocated data channel of a digital program stream (e.g., digital television stream). The process may include determining an unused portion of bandwidth of the pre-allocated channel, such that metadata may be encoded into the unused portion. It may be appreciated that a program stream may have a pre-defined bandwidth for carrying user data. As such, underutilized bandwidth may be encoded with data. According to another embodiment, encoding data into the pre-allocated data channel may preserve data during transmission through a network, cable or satellite system without corruption or loss of data. As such, metadata encoded in a program stream may be provided to a receiving device.

According to another aspect of the invention, data may be provided to an end user of a broadcast distribution network using a digital program stream. In one embodiment, the invention relates to video signal processing logic or a display device. The invention may be housed in the display device or may be separate and utilized as a component of a video signal interface such as a set top box (STB). This embodiment may also be connected through a video signal interface to the display. To that end, the invention may be housed in a STB which provides data to a display device for use as one of guide data, program data to convey upcoming programming information, data to upgrade manufactures display devices, metadata or user accessible data. The embedded data may also convey network communications data for messages from the network to affiliates, closed captioning data which can then be displayed over the primary video, content advisory data, forensic data used to identify video content and/or audience measurement data. In another embodiment, extracted data may be stored in a memory device, such as random access memory or read only memory.

When implemented in software, the elements of the invention are essentially the code segments to perform the necessary tasks. The program or code segments can be stored in a processor readable medium. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, etc. The code segments may be downloaded via computer networks such as the Internet, Intranet, etc.

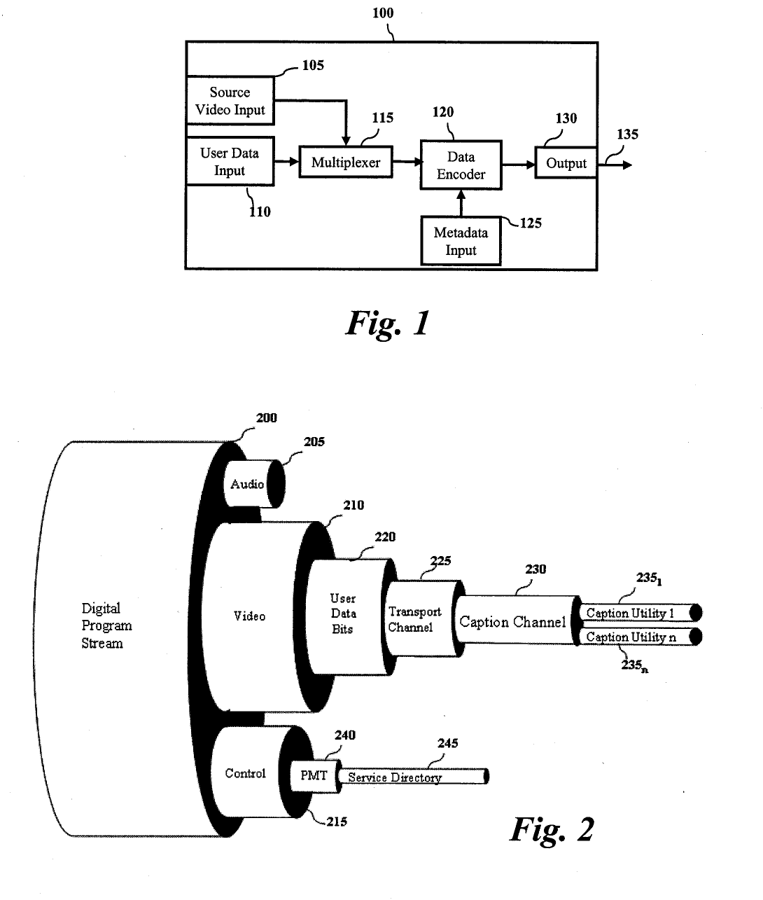

Referring now to the figures, FIG. 1 illustrates a simplified block diagram of video subsystem 100, according to one or more embodiments of the invention. In certain embodiments, video subsystem 100 may be configured to encode metadata into a digital program stream. As shown, video subsystem 100 includes a source video input 105 and a user data input 110 coupled to a multiplexer 115. Source video input 105 may be configured to receive an unformatted digital signal, a formatted digital signal, or any digital signal in general. Similarly, user data input 110 may be configured to receive application-specific user data. In one embodiment, user data input 110 may be configured to receive closed caption (CC) data corresponding to the digital video signal. Multiplexer 115 may be configured to combine the source video input 105 and user data input 110. For example, multiplexer 115 may interleave received video data and user data to form a digital program stream, as will be described in more detail below with respect to FIG. 2, which may then be provided to data encoder 120. In certain embodiments, the digital program stream may include a pre-allocated data channel. The digital program stream may also be a packetized elementary stream.

In one embodiment, data encoder 120 may be coupled to multiplexer 115 and metadata input 125. Metadata input 125 may be configured to receive metadata from a broadcast source. In one embodiment, metadata may be at least one of guide data, program related information, network messages, audience measurement data, forensic markers, closed captioning, ratings, software downloads, and content advisory data. Additionally, metadata received from metadata input 125 may be associated with video data received from source video input 105. Data encoder 120 may be configured to encode metadata received from metadata input 125 into the digital program stream provided by multiplexer 115. For example, data encoder 120 may encode metadata into a pre-allocated data channel of the digital program stream and output the program stream at output interface 130, as digital program stream 135.

Referring now to FIG. 2, an exemplary representation of a digital program stream 200 is shown according to one or more embodiments of the invention. In one embodiment, digital program stream 200 is an embodiment of digital program stream 135, and may be utilized by a broadcast source to provide a digital video signal to a plurality of end user devices. It may also be appreciated that digital program stream 200 may be generated by a video subsystem (e.g., video subsystem 100). According to another embodiment, the digital program stream may conform to at least one of an MPEG format, ATSC format, CEA-708-C standard and any digital television format and/or standard in general. As such, digital program stream 200 may provide at least one of audio data 205, video data 210 and control data 215. In one embodiment, video data 210 may include user data 220, which provides application specific data associated with the video data 210. User data 220 may be defined according to one or more of the aforementioned standards and/or formats. In one embodiment, user data 220 may include styles for CC text including one or more of color for text and background, text size and text font. CC style information may be provided to an end user device for formatting of displayed CC text.

According to another embodiment, user data 220 may include transport channel 225. Transport channel 225 may be configured to provide communications protocol information related to transmission of digital program stream 200. Additionally, transport channel 225 may include caption channel 230. In one embodiment, caption channel 230 contains CC data related to video data 210 of digital program stream 200. As such, caption channel 230 may include a plurality of caption utility channels 235₁-235ₙ. CC data may be stored in one or more of caption utility channels 235₁-235ₙ. CC data may provide at least one of a type of CC data, a CC count associated with the amount of caption utilities and CC text.

In one embodiment, caption channel 230 may have a pre-defined bandwidth. As may be appreciated, caption channel 230 may alternatively have a dynamic bandwidth in certain embodiments of the invention. Bandwidth of caption channel 230 may be defined by one or more of video subsystem 100, multiplexer 115 and any of the aforementioned standards and/or formats. In one embodiment, caption utility channels 235₁-235ₙ may carry closed caption data associated with video data 210. According to another embodiment of the invention, metadata may be encoded into one of caption utility channels 235₁-235ₙ, as previously described with reference to FIG. 1. For example, if a portion of the bandwidth of caption channel 230 is utilized by CC data, metadata may be encoded into the unused portion of the predefined bandwidth of the caption channel 230. To that end, encoding of metadata into caption channel 230 preserves the encoded metadata throughout transmission.

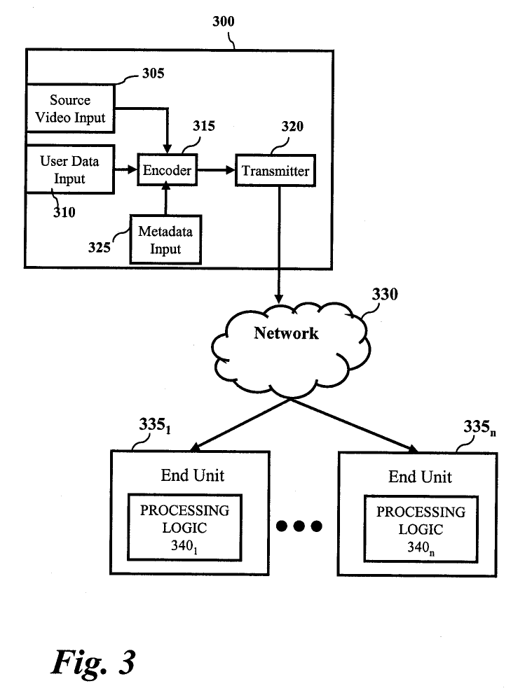

According to another aspect of the invention, caption channel 230 may include elements to identify data contained in caption utility channels 235₁-235ₙ. In one embodiment, caption utility channels 235₁-235ₙ may include a flag element to indicate that data within a caption utility channel is not closed caption data. It may be appreciated that each caption utility channel 235₁-235ₙ may include a single flag element to define data within a channel. It may also be appreciated that a plurality of flag elements may be contained within each caption utility channel 235₁-235ₙ to label data accordingly. As such, a decoder processing digital program stream 200 may disregard the data encoded in a caption utility channel as closed captioning data. According to another embodiment, caption utility channels 235₁-235ₙ may include an identifier to indicate the source of metadata encoded in the channel. The identifier may be a predefined bit sequence associated with a particular source. For example, identifiers issued from the Society of Motion Picture and Television Engineers (SMPTE) Registration Authority may be associated with metadata encoded in a caption utility channel (e.g., caption utility channel 235₁-235ₙ). In another embodiment, a starting bit value may be provided within a caption service channel, such that processing logic, as will be described in more detail with respect to FIG. 3, may be provided with the starting bit of encoded metadata.

According to another embodiment of the invention, digital program stream 200 may include control data 215. Control data 215 may be used to allow for control of display or data in caption channel 230. As may be appreciated, an end user device receiving digital program stream 200 may use control data 215 to adjust display parameters of data provide by the digital program stream. According to another embodiment, control data 215 may include Program Mapping Table (PMT) data 240. PMT data 240 may be used to identify and indicate the locations of data that make up each caption utility channel 235₁-235ₙ. PMT 240 may additionally provide the location of a Program Clock Reference field for caption utility channel 235₁-235ₙ. According to another embodiment, PMT data 240 may include service directory data 245 to provide selection of a CC style.

Referring now to FIG. 3, a simplified system diagram is shown according to one or more embodiments of the invention. Video subsystem 300 (e.g., video subsystem 100) may be configured to provide a digital program stream (e.g., digital program stream 200) to a plurality of end user devices 335₁-335ₙ via broadcast network 330. In one embodiment, back end system 300 may include encoder 315 coupled to transmitter 320. Further, back end system 300 may include source video input 305, user data input 310 and metadata input 325. As such, encoder 315 may be configured to generate a digital program stream from video data received at source video input 305 and data received user data input 310. Further, metadata received at metadata input 325 may be encoded into the digital program stream by encoder 315. In one embodiment, video data received at source video input 305 may conform to at least one of a Digital Video Broadcasting (DVB), Digital Satellite System (DSS), Digital Broadcast system (DBS), Advanced Television Standards Committee (ATSC), Society of Cable Telecommunications Engineers (SCTE), Internet Protocol Television (IPTV), etc. Transmitter 320 may be configured to package and transmit the encoded digital program stream (e.g., digital program stream 135) to end user devices 335₁-335ₙ via network 330.

According to another embodiment, end user devices 335₁-335ₙ may receive broadcasted digital program streams via network 330. As may be appreciated, network 330 may be one of a wired network, wireless network and combination thereof. To that end, end unit devices 335₁-335ₙ may be display devices or may be separate and utilized as components of a video signal interface such as a STB. In one embodiment, end unit devices 335₁-335ₙ may include a digital television tuner. According to an additional embodiment, end unit devices 335₁-335ₙ may include processing logic 340₁-340ₙ. Processing logic 340₁-340ₙ may be configured to receive and decode the digital program stream for display. Similarly, processing logic 340₁-340ₙ may be configured to extract data from a pre-allocated data channel (e.g., caption channel 230) of a received digital program stream. In one embodiment, processing logic 340₁-340ₙ may identify data to be extracted based on a flag associated with a caption utility channel (e.g., caption utility channel 235₁-235ₙ). Encoded metadata may also be identified using one of a broadcast identifier and start bit. For example, a SMPTE identifier may be used to identify the broadcast source. Similarly, logic 340₁-340ₙ may utilize a start bit provided in a caption utility channel, as detailed above, with reference to FIG. 2. In yet another embodiment, end unit devices 335₁-335ₙ may interoperate with existing devices, such as a tuner or STB for extracting encoded metadata. Extracted metadata may be used for one of guide data, program related information, network messages, audience measurement data, forensic markers, closed captioning, ratings and software downloads, and content advisory data. In another embodiment, logic 340₁-340ₙ may store extracted data in a memory.

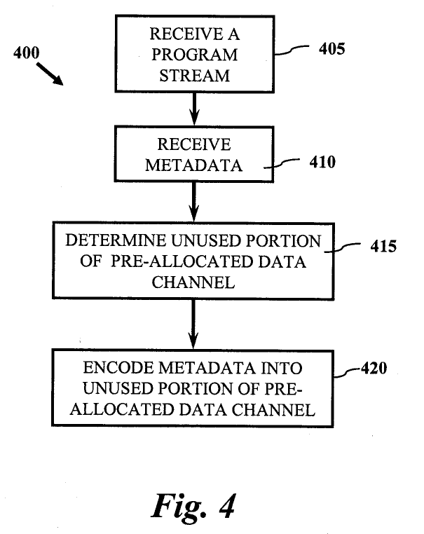

Referring now to FIG. 4, process 400 is shown for encoding metadata into a digital program stream according to one or more embodiments of the invention. Process 400 may include receiving a digital program stream at block 405 (e.g., using source video input 105 of FIG. 1). As such, the digital program stream may include a pre-allocated data channel having a pre-defined bandwidth. Metadata may be received at block 410. In one embodiment, metadata may be received by an encoder (e.g., data encoder 120 of FIG. 1) configured to encode a digital program stream with the metadata.

Process 400 continues with a determination of an unused portion of a pre-defined bandwidth of the pre-allocated channel at block 415. In one embodiment, an encoder (e.g., encoder 120) may be configured to determine the available bandwidth of the pre-allocated channel, which in one embodiment may be a closed caption channel, as described above with reference to FIG. 2. Thus the encoder (e.g., data encoder 120) may be configured to determine the available bandwidth of a closed caption channel. Based on the determination of available bandwidth, metadata may be encoded into the unused portion at block 420. Encoding may include labeling the metadata with an identifier. As such, the identifier may provide at least one of a start bit for metadata encoded in the pre-allocated data channel and an identity of a source of the metadata. Similarly, encoding may include setting a flag of the pre-allocated channel to indicate that encoded metadata will not be recognized as closed caption data. As may be appreciated, the digital program stream with encoded metadata may be transmitted to an end unit device (e.g., end unit devices 335₁-335ₙ).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for encoding data into a digital program stream, the method comprising the acts of:
receiving a digital program stream having a pre-allocated data channel, the pre-allocated data channel having a pre-defined bandwidth;
receiving metadata;
determining an unused portion of said pre-defined bandwidth of the pre-allocated channel; and
encoding the metadata into said unused portion of said pre-defined bandwidth.

2. The method of claim 1, wherein the digital program stream conforms to a digital television broadcast format.

3. The method of claim 2, wherein the digital television broadcast format is one of a MPEG format, ATSC format and CEA-708-C format.

4. The method of claim 1, wherein the pre-allocated data channel is a closed caption data channel.

5. The method of claim 1, wherein metadata comprises at least one of guide data, program related information, network messages, audience measurement data, forensic markers, closed captioning, ratings and software downloads, and content advisory data.

6. The method of claim 1, wherein encoding comprises labeling the metadata with an identifier.

7. The method of claim 6, wherein the identifier provides at least one of a start bit for metadata encoded in the pre-allocated data channel, and an identity of a source of the metadata.

8. The method of claim 1, wherein encoding further comprises setting a flag of the pre-allocated channel to indicate that encoded metadata will not be recognized as closed caption data.

9. An apparatus for encoding metadata into a video signal comprising:
a program stream input;
a metadata input; and
an encoder coupled to said program stream input and metadata input, said encoder configured to:
receive a digital program stream using the program stream input, wherein the digital program stream has a pre-allocated data channel, the pre-allocated data channel having a pre-defined bandwidth,
receive metadata using the metadata input,
determine an unused portion of said pre-defined bandwidth of the pre-allocated channel, and
encode the metadata into said unused portion of said pre-defined bandwidth.

10. The apparatus of claim 9, wherein the digital program stream conforms to a digital television broadcast format.

11. The apparatus of claim 10, wherein the digital television broadcast format is one of a MPEG format, ATSC format and CEA-708-C format.

12. The apparatus of claim 9, wherein the pre-allocated data channel is a closed caption data channel.

13. The apparatus of claim 9, wherein the metadata comprises at least one of guide data, program related information, network messages, audience measurement data, forensic markers, closed captioning, ratings and software downloads, and content advisory data.

14. The apparatus of claim 9, wherein said encoder is further configured to encode the metadata by labeling the metadata with an identifier.

15. The apparatus of claim 14, wherein the identifier provides at least one of a start bit for metadata encoded in the pre-allocated data channel, and an identity of a source of the metadata.

16. The apparatus of claim 9, wherein said encoder is further configured to encode the metadata by setting a flag of the pre-allocated channel to indicate that encoded metadata will not be recognized as closed caption data.

17. A method for encoding data into a digital program stream, the method comprising the acts of:
receiving digital video content intended for television broadcast;
receiving user data;
multiplexing said digital video content and said user data to generate a digital program stream having a pre-allocated data channel, the pre-allocated data channel having a pre-defined bandwidth;
determining an unused portion of said pre-defined bandwidth of the pre-allocated channel; and
encoding metadata into said unused portion of said pre-defined bandwidth.

18. The method of claim 17, wherein the digital program stream conforms to a digital television broadcast format.

19. The method of claim 18, wherein the digital television broadcast format is one of a MPEG format, ATSC format and CEA-708-C format.

20. The method of claim 17, wherein the pre-allocated data channel is a closed caption data channel.

21. The method of claim 17, wherein metadata comprises at least one of guide data, program related information, network messages, audience measurement data, forensic markers, closed captioning, ratings and software downloads, and content advisory data.

22. The method of claim 17, wherein encoding comprises labeling the metadata with an identifier.

23. The method of claim 22, wherein the identifier provides at least one of a start bit for metadata encoded in the pre-allocated data channel, and an identity of a source of the metadata.

24. The method of claim 17, wherein encoding further comprises setting a flag of the pre-allocated channel to indicate that encoded metadata will not be recognized as closed caption data.
